(19) United States
(12) Patent Application Publication
(10) Pub. No.: US 2023/0304717 A1
(43) Pub. Date: Sep. 28, 2023

(54) WATER FILL TUBE WITH THERMALLY CONDUCTIVE FILLED POLYMER

(71) Applicant: WHIRLPOOL CORPORATION, Benton Harbor, MI (US)

(72) Inventors: Sarah M. GALEA, St. Joseph, MI (US); Chad M. ROTTER, Saugatuck, MI (US)

(21) Appl. No.: 17/700,985

(22) Filed: Mar. 22, 2022

(51) Int. Cl. F25C 1/25; F16L 9/12

(52) U.S. Cl. CPC F25C 1/25; F16L 9/12; F25C 2500/08

(57) ABSTRACT

A refrigeration appliance includes an appliance body defining a plurality of compartments, and an ice making system in a first compartment of the plurality of compartments with an ice making compartment disposed therein. The refrigeration appliance also includes a water fill tube extending from a second compartment of the plurality of compartments to the first compartment to supply water to the ice making compartment, the water fill tube having a body with an inner surface defining a cavity for flowing water and an outer surface. The body includes at least a portion with a thermally conductive filler dispersed in a polymer material. The refrigeration appliance also includes a heating device configured to supply heat to the water fill tube, where the thermally conductive filler conducts heat along and through a thickness of the body to melt ice and prevent ice build-up in the water fill tube.

### TECHNICAL FIELD

The present disclosure relates to a refrigeration appliance with a water fill tube, and more specifically, reducing ice formation within water fill tubes in an ice making system.

### BACKGROUND

Household appliances, such as refrigerators and freezers, typically include water lines and fill tubes (hereinafter interchangeably referenced) for supplying water to various devices such as the ice making system. These water fill tubes are susceptible to freezing given the cold environment. Conventional water fill tubes are formed of plastic, which has generally insulative properties. For example, the thermal conductivity of high-density polyethylene (HDPE) is about 0.2 to 0.3 W/m-K in the temperature range of -15 to 40° C. Conventional refrigerators and freezers include a foil heater to transfer heat to the ice formed inside the water fill tube by using a heater wire placed between foil sheets and adhered to the surface of the tube or wrapping the heater wire around the tube covering the wire with an aluminum foil sheet with adhesive backing. However, because of the insulative properties of the water fill tube material, heat transfer to the ice within the water fill tube is limited. Furthermore, for portions of the water fill tube supplying an ice making system that are positioned within an ice making compartment, the heat transfer from the foil heater to the ice inside the water fill tube is further limited due to distance and heat loss between these portions and the foil heater.

### SUMMARY

According to one or more embodiments, a refrigeration appliance includes an appliance body defining a plurality of compartments, and an ice making system in a first compartment of the plurality of compartments with an ice making compartment disposed therein. The refrigeration appliance also includes a water fill tube extending from a second compartment of the plurality of compartments to the first compartment to supply water to the ice making compartment, the water fill tube having a body with an inner surface defining a cavity for flowing water and an outer surface. The body includes at least a portion with a thermally conductive filler dispersed in a polymer material. The refrigeration appliance also includes a heating device configured to supply heat to the water fill tube, where the thermally conductive filler conducts heat along and through a thickness of the body to melt ice and prevent ice build-up in the water fill tube.

In at least one embodiment, the thermally conductive filler may be aluminum, graphite, copper, zinc, glass fiber, or combinations thereof. Furthermore, the thermally conductive filler may be provided as flakes having an average volume of 5 to 75 mm3. In at least one embodiment, the polymer material may be high density polyethylene, cross-linked polyethylene, or polyethylene. In certain embodiments, the thermally conductive filler may increase a thermal conductivity of the portion of the water fill tube by half to 16 times of an unfilled polymer material. According to at least one embodiment, the water fill tube may include a first portion corresponding to a section of the water fill tube external to the ice making compartment, and a second portion corresponding to a section of the water fill tube within the ice making compartment, with at least the second portion including the thermally conductive filler dispersed in the polymer material. In at least one further embodiment, the heating device may be positioned to supply heat to the first portion. In some further embodiments, the second portion includes an end body with thermally conductive filler dispersed in the polymer material. In one or more embodiments, the thermally conductive filler may be loaded in the polymer material at 0.5 to 25% by weight.

According to one or more embodiments, a water fill tube for a refrigeration appliance, the water fill includes a body having an inner surface defining a cavity for flowing water, and an outer surface. The body includes a thermally conductive filler dispersed in a polymer material. The thermally conductive filler conducts heat from the outer surface such through and along the body to melt ice and prevent ice build-up in the cavity.

In at least one embodiment, the thermally conductive filler may be aluminum, graphite, copper, zinc, glass fiber, or combinations thereof. In certain embodiments, the thermally conductive filler may be provided as flakes having an average volume of 5 to 75 mm3. In one or more embodiments, the thermally conductive filler may be loaded in the polymer material at 0.5 to 25% by weight. In at least one embodiment, the thermally conductive filler may increase a thermal conductivity of the body by half to 16 times of an unfilled polymer material. According to at least one embodiment, the water fill tube may further comprise a heating device on a first portion of the body to supply heat to the portion, wherein the thermally conductive filler may be included in a second portion of the body, different from the first portion. In one or more embodiments, the polymer material may be high density polyethylene, cross-linked polyethylene, or polyethylene.

According to one or more embodiments, a water fill tube for a refrigeration appliance includes a first body having a first inner surface defining a first inner cavity for flowing water, and a first outer surface, and a second body positioned on an end of the first body. The second body defines a second inner cavity for flowing water and a second outer surface, and is formed of a polymer material with a thermally conductive filler dispersed therein. The water fill tube further includes a heating device positioned on at least a portion of the first outer surface of the first body. The heating device heats the portion of the first outer surface of the first body such that heat conducts to the second body and the thermally conductive filler conducts heat from the second outer surface to the second inner cavity of the second body to melt ice and prevent ice build-up in the second inner cavity.

In at least one embodiment, the thermally conductive filler may be aluminum, graphite, copper, zinc, glass fiber, or combinations thereof. In certain embodiments, the thermally conductive filler may be provided as flakes having an average volume of 5 to 75 mm3. In one or more embodiments, the thermally conductive filler may be loaded in the polymer material of the second body at 0.5 to 25% by weight.

### BRIEF DESCRIPTION OF THE DRAWINGS

FIG. 1A is a schematic illustration of a refrigeration appliance, according to an embodiment;

FIG. 1B is a schematic illustration of an ice making system of the refrigeration appliance of FIG. 1A, according to an embodiment;

FIG. 2A is a schematic illustration of an example of an ice making system, according to an embodiment;

FIG. 2B is a partial schematic illustration of an example of a water fill tube for ice maker compartment, according to an embodiment;

FIG. 3 is partial schematic illustration of an example of a water fill tube, according to an embodiment; and

FIG. 4 is a partial schematic illustration of the water fill tube of FIG. 3 with a heating device, according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

According to one or more embodiments, a refrigeration appliance includes a water fill tube susceptible to freezing and a heating device, such as a foil heater. In certain embodiments, as described hereinafter, the water fill tube may be described with reference to an ice making system with an ice making compartment, however this is not intended to be limiting, and the water fill tube may be used for any water fill tube in the refrigeration appliance that is susceptible to freezing. In at least one embodiment, the water fill tube is constructed from a polymer material (e.g., high-density polyethylene (HDPE), cross-linked polyethylene (PEX), polyethylene (PE), or other suitable plastic that can withstand the environment within the refrigeration appliance) with a thermally conductive filler dispersed therein to improve heat transfer through the tube to prevent ice build-up and melt ice. In one or more embodiments, where the water fill tube is supplying water to the ice making system, the water fill tube may extend into the ice making compartment, such that the thermally conductive filler allows for heat to conduct into the portion of the water fill tube positioned within the ice making compartment. As such, thermally conductive filler improves heat transfer from the external foil heater to the ice formed within the water fill tube to reduce blockages within the water fill tube, and in embodiments where the water fill tube is supplying an ice making system, improve performance of the ice making system.

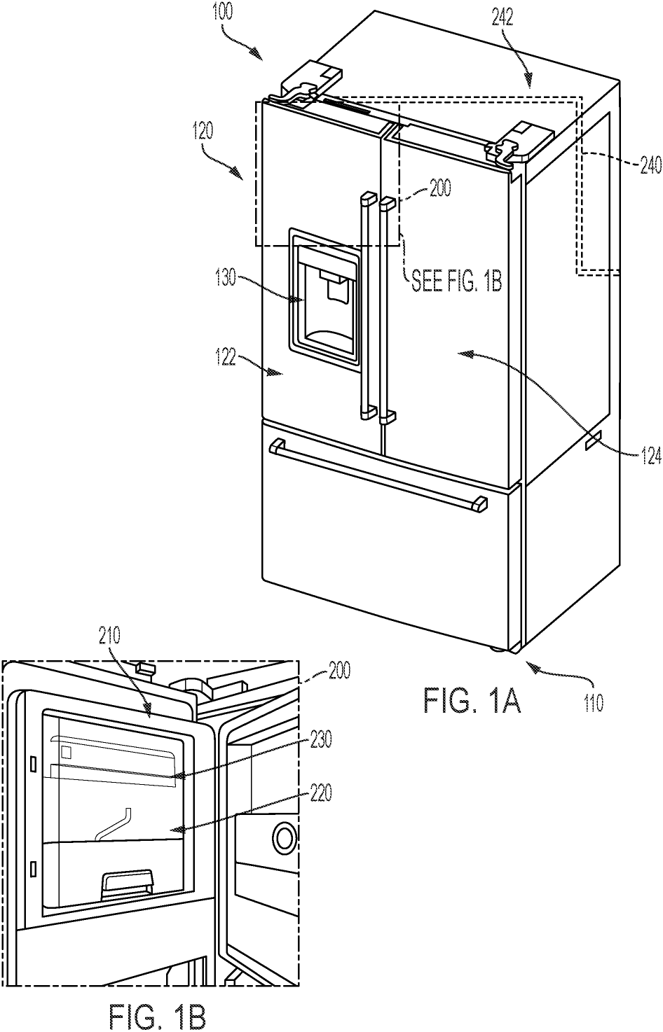

Referring to FIG. 1A, an example of a refrigeration appliance 100 is shown. The refrigeration appliance 100 may be any household or commercial refrigeration appliance including, but not limited to, refrigerators, freezers, chillers, and combinations thereof, and hereinafter is referred to refrigeration appliance 100. The refrigeration appliance 100 may include various compartments to form the refrigeration appliance 100, including, but not limited to, freezer compartments, refrigerator compartments, and combinations thereof. In the example of FIGS. 1, the refrigeration appliance 100 includes a freezer compartment 110 and a refrigerator compartment 120. The refrigeration appliance 100 may include any suitable mechanisms for operation, including, but not limited to, an evaporator, a condenser, a compressor, and the like, and are not depicted herein, with only the relevant components for context being described hereinafter.

The refrigeration appliance 100 may be constructed in any suitable manner, and the depiction of a refrigeration appliance 100 with a freezer compartment 110 configured as a drawer 112 and a refrigerator compartment 120 configured with french doors 122, 124 is not intended to be limiting. For example, the refrigeration appliance 100 may have a freezer compartment 110 and a refrigerator compartment 120 side by side, or in other examples, have the refrigerator compartment 120 below a freezer compartment 110, and may further have any suitable number of doors, compartments, and drawers to configure the refrigeration appliance 100.

In one or more embodiments, as shown in the example of FIG. 1A, the refrigeration appliance 100 includes a dispenser 130 for dispensing water and/or ice from the refrigeration appliance 100. The dispenser 130 is configured to receive water from a corresponding water tube (not shown) and/or ice from an ice making system 200 within the refrigeration appliance 100. However, although shown in FIG. 1A on the external surface of the French door 122 to the refrigerator compartment 120, the dispenser 130 may be located in any other suitable location, including, but not limited to within the freezer compartment 110 or within the refrigerator compartment 120. Moreover, in certain embodiments, the dispenser 130 may be excluded, and the refrigeration appliance 100 may include an ice tray or storage compartment 220 configured to store ice for access by a user upon opening the refrigeration appliance 100 (e.g., in the freezer compartment 110 or in the refrigerator compartment 120). Ice for dispensing via the dispenser 130 or storage in an ice tray or storage compartment 220 is included in the ice making system 200. The ice making system 200 may be located within the refrigerator compartment 120, as shown in FIG. 1A, or may be located in any other suitable location within the refrigeration appliance 100 (e.g., the freezer compartment 110), and the depiction in the refrigerator compartment 120 is not intended to be limiting.

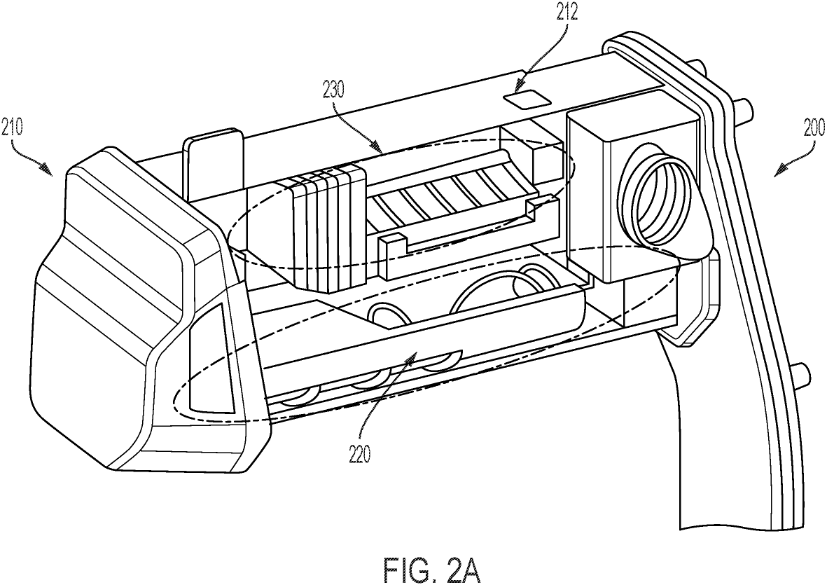

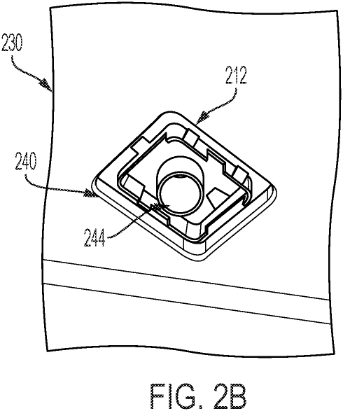

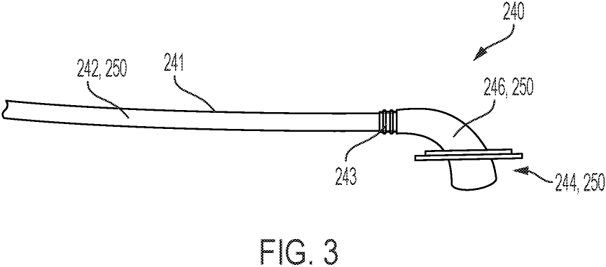

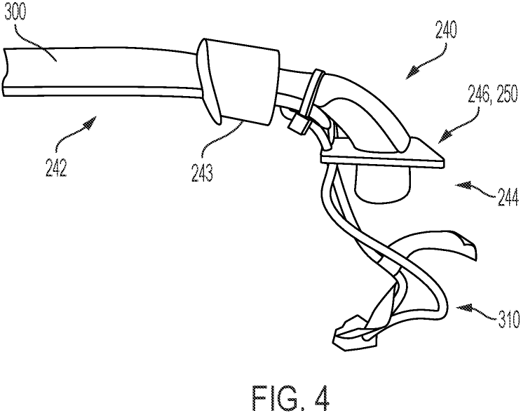

Referring to the examples of the ice making system 200 shown in FIG. 1B and FIGS. 2A-B, the ice making system 200 includes a housing 210 with an ice storage compartment 220 positioned below an ice making compartment 230. The ice making compartment 230 may be configured as a tray (see the example of FIG. 2A), and may be connected to a power supply to power a motor for ice formation and dispensing of ice to the dispenser 130 or the ice storage compartment 220. A water fill tube 240 (not shown in FIGS. 2A-B) (or interchangeably, water tube or water fill line) supplies water to the ice making system 200, with a first portion 242 of the water fill tube 240 being external to the housing 210 and ice making compartment 230, and a second portion 244 being within ice making compartment 230. Details of the water fill tube 240 will be described with reference to FIGS. 3-4 below. The water fill tube 240 extends through an opening 212 into the compartment 230, as depicted in the example of FIG. 2A. As such, as shown in FIG. 2B, the second portion 244 of the water fill tube 240 may be positioned to supply water to the ice making compartment 230 via a suitable mechanism, such as a nozzle (not shown). Furthermore, as shown in FIG. 1A, the first portion 242 of the water fill tube 240 may be routed through the various parts of the refrigeration appliance 100 as based on the overall design of the refrigeration appliance 100 and for connection to a water source. The ice making system 200 includes any other suitable components related to the operation of the ice making system 200, including, but not limited to, valves, tubes/drains, and corresponding controllers to direct water to and drain water from the ice making system 200, and other conventional features.

Although described as a water fill tube 240 for the ice making system 200, the water fill tube 240 may be any suitable water fill tube in the refrigeration appliance 100 such as the water tube supplying water to the dispenser 130. As such, although the water fill tube 240 will be described in the below examples with reference to the ice making assembly 200, any suitable water fill tube included in the construction of the refrigeration appliance 100 is contemplated, and discussion with the water fill tube with respect to the ice making system 200 is not intended to be limiting. Thus, even if the water fill tube 240 is not supplying the ice making system 200, it may still be susceptible to freezing based on the water fill tube being split between the outside of housing 210 and inside (e.g., being in the open cabinet vs. foamed in), and the water fill tube 240 may be constructed according to the embodiments described below, without limitation.

Referring to FIG. 3, the water fill tube 240 includes a polymer material with a thermally conductive filler dispersed therein. At least a portion of the water fill tube 240 includes the thermally conductive filler dispersed within a polymer matrix. The portion may be selected as based on the portion of the water fill tube 240 that is within a cooled area of the refrigeration appliance 100, where excessive heat would affect performance in some embodiments (e.g., the ice making compartment 230 which operates at 15 to 20° F.), and in other embodiments, may be based on the portion where a heating device is unable to directly heat the water fill tube 240. In certain embodiments, the whole water fill tube 240 includes the thermally conductive filler. In yet further embodiments, a portion of the water fill tube 240 includes additional features that include the thermally conductive filler dispersed within the polymer matrix. An example of a portion of the water fill tube with the thermally conductive filler will be discussed below with reference to the water fill tube 240 for the ice making system 200.

In at least one embodiment, the water fill tube 240 comprises a body 241 (e.g., a tube) having an inner surface defining a cavity therein for flowing water to the ice making system 200, and an outer surface, opposite to the inner surface, extending about the periphery and along the length body. The body 241 may be formed from a single unitary polymer material, or include layers of the polymer material to form the body 241. In embodiments where the body 241 is a layered structure, one or more of the polymer materials may be used in the construction of the body. The thickness of the body 241 (as defined between the inner surface and the outer surface) may be, in some embodiments 0.5 to 2.0 mm, in other embodiments 0.75 to 1.75 mm, and in yet further embodiments 1.0 to 1.5 mm. Moreover, the body may have an outer diameter, from a center of the body 241 to the outer surface, of 5.5 to 8.5 mm in some embodiments, 5.75 to 8.25 mm in other embodiments, and 6.0 to 8.0 mm in yet other embodiments. Additionally, the body may have an inner diameter, from a center of the tubular body to the inner surface, of 3.5 to 6.0 mm in some embodiments, 3.75 to 5.75 mm in other embodiments, and 4.0 to 5.5 mm in yet other embodiments. The thickness may be formed via a single layer of polymer material or be constructed via layers forming the overall thickness of the body 241.

The polymer material may be HDPE, PEX, PE, or other suitable plastic that can withstand the temperatures (i.e., maintain its structural integrity) as based on the location of the water fill tube 240 the refrigeration appliance (e.g., in the refrigerator or freezer compartment 120, 110 interior, within the foamed in insulation, within the housing 210, and/or within the ice making system 200). In certain embodiments, the water fill tube 240 may include combinations of HDPE, PEX, PE or other suitable plastic. For example, the water fill tube 240 shown in FIG. 3 is a water tube for the ice making system 200. As shown in FIG. 3, for a water fill tube 240 for the ice making system 200, the water fill tube 240 may include a body 241 with the first portion 242 external to the ice making compartment 230 and a second portion 244 positioned within the ice making compartment 230 (as shown in FIG. 2B). One or both of the first portion 242 and the second portion 244 may include a thermally conductive filler in the polymer material.

In certain embodiments, as shown in FIG. 3, the second portion 244 may include an end body 246 positioned on an end 243 of the first portion 242. In the example of FIG. 3, the first portion 242 may be a PEX material (e.g., an extruded PEX), and the end body 246 may be HDPE. In the example of FIG. 3, the second portion 244 of the water fill tube 240 for the ice making system 200 includes the end body 246, with the end body 246 including the thermally conductive filler dispersed in the polymer matrix (i.e., HDPE) to improve thermal conduction to the cavity. The end body 246 may be injection molded or over molded onto the end 243 of the first portion 242. The end body 246 may also be a tubular structure, and may have a thickness of 0.5 to 2.0 mm in some embodiments, 0.75 to 1.75 mm in other embodiments, and 1.0 to 1.5 mm in yet further embodiments. Although shown as having a curved shape, the end body 246 may have any suitable shape or curvature as based on the location and routing of the water fill tube 240 within the refrigeration appliance 100, or may be omitted in other examples where the first portion 242 includes the thermally conductive filler.

In further examples (not shown), the polymer material forming the body 241 may be HDPE, such that the water fill tube 240 may be positioned within the insulation and/or the ice making compartment 230, and in other examples, where the polymer material is PEX, the water fill tube 240 may be inside the housing 210 but outside the ice making compartment 230. The water fill tube 240 may be formed using any suitable process based on the polymer material and the desired dimensions, such as, but not limited to, over-molding, injection molding, extruding, or combinations thereof. Generally, the water fill tube 240 of the present disclosure can be used in any suitable location where water may freeze within the line and have additional components to form the water fill tube such that the water fill tube 240 can be used in conjunction with an external heating device 300, described in further detail below.

The thermally conductive filler may be any suitable material that improves the thermal conductivity of the polymer material to increase heat transfer from the outside surface to the inside surface, and thus the cavity, when compared with a water fill tube that does not include the thermally conductive filler. Furthermore, the thermally conductive filler facilitates heat transfer along the length of the water fill tube 240, as based on the first portion 242, the second portion 244, or both including a thermally conductive filler. The thermally conductive filler may be, in some embodiments, a conductive powder, conductive flakes, or other conductive particles. The thermally conductive filler may be a suitable material for improving the thermal conductivity of the water fill tube 240, such as, but not limited to aluminum, zinc, graphite, copper, or other suitable thermally conductive filler (e.g., glass fibers), or combinations thereof, that can be loaded in the polymer matrix in flake, powder, fiber, or particle form. The inclusion of the thermally conductive filler improves the overall thermal conductivity of the water fill tube 240, as measured by ASTM E1461 and international standards DIN EN 821, DIN 30905 and ISO 22007-4:2008. In some embodiments, the thermal conductivity is increased by half to 20 times compared to the unfilled polymer material in some embodiments, half to 18 times in other in embodiments, and half to 16 times in yet further embodiments. As such, in examples where the polymer material is HDPE, the thermal conductivity may be, in some embodiments, at least 0.3 W/m-K in the temperature range of -15 to 40° C., and in other embodiments, at least 0.45 W/m-K. In some embodiments, the thermal conductivity may be increased to at least 1.0 W/m-K, and in other embodiments, the thermal conductivity may be increased to at least 2.0 W/m-K. In certain embodiments where the polymer material is HDPE, the thermal conductivity may be increased up to 4.8 W/m-K. In certain embodiments, the thermally conductive filler may be added in such amount such that the thermal conductivity may be increased to up to 5.5 W/m-K. As such, the thermal conductivity of the polymer material with the thermally conductive material may be 0.3 to 5.5 W/m-K. However, the thermal conductivity may vary based on the polymer material used, and the increase in thermal conductivity may be quantified by the multiplier (e.g., half to 20 times) of the thermal conductivity of the polymer material, and discussion of particular ranges is not intended to be limiting.

The thermally conductive filler may be loaded into the polymer material in any suitable quantity to improve the conductivity of the water fill tube 240. In some embodiments, the thermally conductive filler may be loaded in the polymer matrix as 0.5-25% by weight in some embodiments, 0.75-22.5% by weight in other embodiments, and 1.0-20% by weight in yet other embodiments. In some examples where the thermally conductive filler may be flakes (e.g., aluminum flakes), the individual flakes may have an average volume of 5 to 75 mm³ in some embodiments, 7 to 65 mm³ in other embodiments, and 9 to 60 mm³ in yet further embodiments. However, the size and shape of the thermally conductive filler may vary as based on the material selected as based on the required conductivity through the water fill tube 240 given environmental parameters and rating of the heating device. Features of the thermally conductive filler may be discussed with respect to the thermally conductive filler being aluminum flakes, however this is not intended to be limiting, and certain parameters may be selected based on the specific thermally conductive filler used for increasing the thermal conductivity of the water fill tube 240. In one or more embodiments, the water fill tube 240 with the thermally conductive filler may have a thermal conductivity of 0.3 W/m-k to 10.0 W/m-k in some embodiments, of 0.4 W/m-k to 7.5 W/m-k in other embodiments, and of 0.5 W/m-k to 5.0 W/m-k in yet further embodiments. However, the thermal conductivity may vary based on the polymer material used, and the increase in thermal conductivity may be quantified by the multiplier (e.g., half to 20 times) of the thermal conductivity of the polymer material, and discussion of particular ranges is not intended to be limiting.

The refrigeration appliance 100 further includes a heating device 300 positioned to supply heat to the outer surface of the water fill tube 240, such that the thermally conductive filler facilitates heat transfer through the body to the inner surface to melt ice formed inside the cavity of the water fill tube 240. The heating device 300 may be any suitable heating device for heating the water fill tube 240, including, but not limited to a foil heater. Referring to FIG. 4, an example of the water fill tube 240 of FIG. 3 is shown with a heating device 300 on a portion of the water fill tube 240. In the example of FIG. 4, the heating device 300 is a foil heater positioned on the outer surface of the first portion 242 of the water fill tube 240, with at least a portion of the second portion 244 (e.g., the end body 246) being without the heating device 300, such that the second portion 244 with the end body 246 corresponds to the part of the water fill tube 240 positioned within the ice maker compartment 230 (see FIG. 2B). Thus, the heating device 300 is applied on the water fill tube 240 outside of the ice making compartment 230. As such, in one or more embodiments, the heating device 300 may be located in the refrigeration appliance 100 and be positioned such that the heating device 300 is thermally isolated from the freezer compartment 110 and the refrigerator compartment 120 to maintain the desired temperatures within those compartments. For example, the first portion 242 may be within the housing 210 or within the insulation (e.g., polyurethane foam) of the refrigeration appliance 100, with only the second portion 244 being exposed to the ice making compartment 230. As such, as shown in FIG. 4, the cavity of the body 241 at the first portion 242 is heated via the heating device 300, and the cavity within the second portion 244 is heated via the thermally conductive filler in the end body 246 facilitating heat transfer from the outer surface and the first portion 242 to the second portion 244, without the heating device 300 extending into the ice making compartment 230. The heating device 300 may have any suitable arrangement to power the heating device, as per the rating of the heating device 300. For example, the heating device 300 includes electrical contacts 310 for receiving current to heat the water fill tube 240. The heating device 300 may be powered at any suitable wattage under DC voltage to generate a surface temperature of the heating device suitable for melting ice within the water fill tube 240. For example, the wattage may be, in some embodiments, 1 to 3 W DC voltage. In certain embodiments, the surface temperature of the heating device may reach 50 to 100° F.

In one or more embodiments, as shown in the example of FIG. 4, the heating device 300 is positioned on a portion of the water fill tube 240, and powered via the electrical contacts 310. In the examples of the ice making system 20, the portion is the first portion 242, which is located outside of the ice making compartment 230 as to avoid impacting the performance and operation of the ice making system 200. As such, in the example shown in FIG. 4, the heating device 300 is positioned to provide heat the outer surface of the water fill tube 240 at the first portion 242 outside of the ice making compartment 230, with the thermally conductive filler in the end body 246 facilitating heat conduction to the second portion 242 within the ice storage compartment 220. In other embodiments, not shown, the heating device 300 may further be located outside the housing 210, such that the second portion is defined internal to the housing 210 and the ice storage compartment 230, and the heat is conducted from the first portion 242 external to the housing 210 to the second portion 244 to melt ice formed within the tubular body of the water fill tube 240. Thus, the heating device 300 does not directly supply heat to the outer surface of the second portion 244 of the water fill tube 240 within the ice making compartment (and, in some embodiments, in the housing 210) or to the end body 246. The thermally conductive filler loaded in the matrix of the water fill tube 240 allows heat to conduct along the length of the water fill tube 240, and also allows for improved heat transfer in areas without the heating device 300, such as from the first portion 242 with the heating device 300, to the second portion 244 to melt ice within the cavity along the length of the water fill tube 240, including in the second portion 244.

The refrigeration appliance 100 further includes a controller (not shown) configured to operate the heating device 300. The heating device 300 may be operated in any suitable manner, including, but not limited to, based on sensor feedback (e.g., ice presence/build up in the water tube), based on a percentage of time of the ice making cycle, or on a percentage of time, and the like. For example, upon receipt of data indicative of an ice blockage in a water tube, the controller may operate the heating device 300 to heat the first portion 242 of the water tube 240 such that ice can be melted. The sensor may be positioned in the first portion 242 or the second portion 244, or be located in both, with the time of operating the heating device varying based on the ability of the water fill tube 240 to conduct heat from the first portion 242 to the second portion 244 if ice is detected in the second portion 244.

According to one or more embodiments, a refrigeration appliance includes an ice making system with a housing having an ice making compartment within, a water fill tube extending through the housing into the ice making compartment, and a heating device positioned outside the ice compartment (and in some embodiments, outside the housing). The heating device may be any suitable heating device, such as a foil heater. The water fill tube has a first portion outside the ice making compartment and extending out of the housing through an aperture such that water can be routed into the ice making compartment, and a second portion positioned within the ice making compartment. At least a portion of the water fill tube is made of a polymer material with a thermally conductive filler dispersed therein. The thermally conductive filler improves heat transfer from an outer surface of the water fill tube to the inner cavity to prevent ice build-up and melt ice, and also allows for heat to conduct along the length of the water fill tube to facilitate heat transfer to the second portion within the ice making compartment. In certain embodiments, the second portion may include an end body positioned on the second portion, with the end body including the thermally conductive filler. Thus, the heating device can heat the water fill tube to heat the first portion directly, and facilitate melting ice in the second portion by improving thermal conduction via the thermally conductive filler. As such, the thermally conductive filler improves heat transfer from the heating device to the ice formed within the water fill tube to reduce blockages and improve performance of the ice making system.

Except where otherwise expressly indicated, all numerical quantities in this disclosure are to be understood as modified by the word “about”. The term “substantially,” “generally,” or “about” may be used herein and may modify a value or relative characteristic disclosed or claimed. In such instances, “substantially,” “generally,” or “about” may signify that the value or relative characteristic it modifies is within ± 0%, 0.1%, 0.5%, 1%, 2%, 3%, 4%, 5% or 10% of the value or relative characteristic (e.g., with respect to transparency as measured by opacity). Practice within the numerical limits stated is generally preferred. Also, unless expressly stated to the contrary, the description of a group or class of materials by suitable or preferred for a given purpose in connection with the disclosure implies that mixtures of any two or more members of the group or class may be equally suitable or preferred.

As referenced in the figures, the same reference numerals may be used herein to refer to the same parameters and components or their similar modifications and alternatives. For purposes of description herein, the terms “upper,” “lower,” “right,” “left,”“rear,” “front,” “vertical,” “horizontal,” and derivatives thereof shall relate to the present disclosure as oriented in FIGS. 1. However, it is to be understood that the present disclosure may assume various alternative orientations, except where expressly specified to the contrary. It is also to be understood that the specific devices and processes illustrated in the drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. The drawings referenced herein are schematic and associated views thereof are not necessarily drawn to scale.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A refrigeration appliance comprising:
an appliance body defining a plurality of compartments;
an ice making system in a first compartment of the plurality of compartments, the ice making system including an ice making compartment disposed therein;
a water fill tube extending from a second compartment of the plurality of compartments to the first compartment to supply water to the ice making compartment, the water fill tube having a body with an inner surface defining a cavity for flowing water and an outer surface, the body including a first portion positioned outside of the ice making compartment, and a second portion located within the ice making compartment, with at least the second portion including a thermally conductive filler dispersed in a polymer material; and
a heater configured to supply heat to the water fill tube, the heater being positioned outside of the ice making compartment,
wherein the thermally conductive filler conducts heat along and through a thickness of the body to melt ice and prevent ice build-up in the water fill tube while the heater remains outside the ice making compartment.

2. The refrigeration appliance of claim 1, wherein the thermally conductive filler is aluminum, graphite, copper, zinc, or combinations thereof.

3. The refrigeration appliance of claim 2, wherein the thermally conductive filler is provided as flakes having an average volume of 5 to 75 mm³.

4. The refrigeration appliance of claim 1, wherein the polymer material is high density polyethylene, cross-linked polyethylene, or polyethylene.

5. The refrigeration appliance of claim 1, wherein the thermally conductive filler increases a thermal conductivity of the portion of the water fill tube by half to 16 times of an unfilled polymer material.

6. The refrigeration appliance of claim 1, wherein the second portion includes an end body secured to an end of the first portion, and the end body includes the thermally conductive filler dispersed in the polymer material.

7. The refrigeration appliance of claim 1, wherein the heater is positioned to supply heat to the first portion.

8. The refrigeration appliance of claim 1, wherein the first portion includes thermally conductive filler dispersed in the polymer material.

9. The refrigeration appliance of claim 1, wherein the thermally conductive filler is loaded in the polymer material at 0.5 to 25% by weight.

10. A water fill tube for a refrigeration appliance, the water fill tube comprising:
a body having an inner surface defining a cavity for flowing water, and an outer surface, the body including a first portion positioned outside an ice making compartment, and a second portion positioned inside the ice making compartment, at least the second portion including a thermally conductive filler dispersed in a polymer material,
wherein the thermally conductive filler conducts heat from the outer surface such through and along the body from the first portion to the second portion to melt ice and prevent ice build-up in the cavity within the second portion.

11. The water fill tube of claim 10, wherein the thermally conductive filler is aluminum, graphite, copper, zinc, or combinations thereof.

12. The water fill tube of claim 11, wherein the thermally conductive filler is provided as flakes having an average volume of 5 to 75 mm³.

13. The water fill tube of claim 10, wherein the thermally conductive filler is loaded in the polymer material at 0.5 to 25% by weight.

14. The water fill tube of claim 10, wherein the thermally conductive filler increases a thermal conductivity of the body by half to 16 times of an unfilled polymer material.

15. The water fill tube of claim 10, further comprising a heater on a first portion of the body to supply heat to the first portion, wherein the thermally conductive filler is included in a second portion of the body, different from the first portion.

16. The refrigeration appliance of claim 10, wherein the polymer material is high density polyethylene, cross-linked polyethylene, or polyethylene.

17. A water fill tube for a refrigeration appliance, the water fill tube comprising:
A first body having a first inner surface defining a first inner cavity for flowing water, and a first outer surface, the first body being positioned outside an ice making compartment;
a second body positioned on an end of the first body and within the ice making compartment, the second body defining a second inner cavity for flowing water and a second outer surface, the second body being formed of a polymer material with a thermally conductive filler dispersed therein; and
a heater positioned on at least a portion of the first outer surface of the first body and outside the ice making compartment,
wherein the heater heats the portion of the first outer surface of the first body such that heat conducts to the second body and the thermally conductive filler conducts heat from the second outer surface to the second inner cavity of the second body to melt ice and prevent ice build-up in the second inner cavity.

18. The water fill tube of claim 17, wherein the thermally conductive filler is aluminum, graphite, copper, zinc, or combinations thereof.

19. The water fill tube of claim 18, wherein the thermally conductive filler is provided as flakes having an average volume of 5 to 75 mm³.

20. The water fill tube of claim 17, wherein the thermally conductive filler is loaded in the polymer material of the second body at 0.5 to 25% by weight.
